(19) United States
(12) Patent Application Publication
(10) Pub. No.: US 2011/0310057 A1
(43) Pub. Date: Dec. 22, 2011

(54) SUBSTRATE AND MANUFACTURE METHOD THEREOF, LIQUID CRYSTAL DISPLAY, AND TOUCH ADDRESSING METHOD

(75) Inventor: Zheng WANG, Beijing (CN)

(73) Assignee: BEIJING BOE OPTOELECTRONICS TECHNOLOGY CO., LTD., Beijing (CN)

(21) Appl. No.: 13/162,772

(22) Filed: Jun. 17, 2011

(30) Foreign Application Priority Data
Jun. 17, 2010 (KR) 201010208736.X

(51) Int. Cl. G06F 3/044

(52) U.S. Cl. 345/174

(57) ABSTRACT

An array substrate comprises a sub-pixel and a touch-sensitive pixel. The touch-sensitive pixel comprises a sensing TFT, a capacitor, a switching element and a signal line. The drain electrode of the sensing TFT is connected to a first terminal of the capacitor; a first terminal of the switching element is connected to the first terminal of the capacitor, and the second terminal thereof is connected to the signal line, and used to output a voltage at the first terminal to the signal line; the signal line is used to output a voltage at the first terminal to a touch processing unit so that it is analyzed by the touch processing unit to obtain a touch result.

### TECHNICAL FIELD

Embodiments of this invention relates to a substrate, a manufacturing method thereof, a liquid crystal display, and a touch addressing method.

### BACKGROUND

A liquid crystal display (LCD) is a flat panel display that is currently in common use. Nowadays, with development of information society, application of a LCD with touch function is becoming increasingly prevalent.

Generally, to achieve the touch function, a film with touch function is attached onto a liquid crystal panel. The liquid crystal panel is made by assembling an array substrate and a color-filter substrate between which there are provided spacers for supporting and keeping a gap. Liquid crystal is filled in the space between the substrates, and the space is sealed with sealant along the periphery. The film with touch function can be attached onto the color-filter substrate for example.

However, the structure that provides liquid crystal panel with touch function by attaching a film with touch function (i.e., a touch film) onto a surface of the liquid crystal panel as described above makes transmittance of the liquid crystal panel decreased, thereby technical indicators such as screen luminance, contrast and the like are affected and definition of the screen may be lowered, which affects display effect. Meanwhile, the attached touch film may also increase the liquid crystal panel in thickness and weight, and manufacture procedures thereof is relatively complex and production cost is increased. Besides, a touch film which is exposed to the outside may have a shortened life span under effect by external environment.

### SUMMARY

A first aspect of the present invention provides an array substrate including: a base substrate; gate lines and data lines on the base substrate; sub-pixels defined by intersections of gate lines and data lines and used for display; and touch-sensitive pixels also defined by intersections of gate lines and data lines and each comprising a sensing thin film transistor (TFT), a capacitor, a switching element and a signal line; wherein, for each touch-sensitive pixel, the capacitor is formed by overlapping a gate metal thin film for forming the gate lines and a data line metal thin film for forming the data lines on the base substrate, a first terminal of the capacitor is connected to a drain electrode of the sensing TFT, a second terminal of the capacitor is connected to a first gate line which is one of the gate lines and corresponds to a row where the touch-sensitive pixel is located, and a voltage at the first terminal of the capacitor at the time of occurrence of a touch action is higher than that of the capacitor at the time of non-occurrence of a touch action; the sensing TFT, of which a gate electrode is connected to the first gate line and a source electrode is connected to a charging power supply, is used to charge the capacitor when the first gate line is turned on; the switching element is connected between the first terminal of the capacitor and the signal line, and is used to output the voltage at the first terminal to the signal line; and the signal line is used to output the voltage at the first terminal to a driving circuit which judges the occurrence of the touch action from an increase of the voltage at the first terminal.

A second aspect of the present invention provides a method for manufacturing an array substrate, the array substrate comprising a base substrate, gate lines and data lines on the base substrate, sub-pixels defined by intersections of gate lines and data lines and used for display, and touch-sensitive pixels also defined by intersections of gate lines and data lines and each comprising a sensing thin film transistor (TFT), a capacitor, a switching element and a signal line, the method comprising: step 1 of depositing a gate metal thin film on the base substrate, and forming gate lines, gate electrodes, common electrode lines and a second terminal of the capacitor of each touch-sensitive pixel by patterning the gate metal thin film; step 2 of, after step 1, forming a gate insulation layer, a semiconductor layer thin film and a data line metal thin film on the base substrate, and forming semiconductor layer islands, the data lines, source electrodes, drain electrodes, and the signal line and a first terminal of the capacitor of each touch-sensitive pixel by patterning the data line metal thin film and the semiconductor layer thin film, wherein the gate electrodes, the source electrodes, the drain electrodes and the semiconductor layer islands, in combination, constitute TFTs, which comprises TFTs in the sub-pixels and the sensing TFTs of the touch-sensitive pixels; a gate electrode of the sensing TFT of each touch-sensitive pixel is connected to a first gate line which is one of the gate lines and corresponds to the touch-sensitive pixel, a source electrode thereof is connected to a charging power supply, and a drain electrode thereof is connected to the first terminal of the capacitor of the touch-sensitive pixel; the second terminal of the capacitor is connected to the first gate line; the first terminal of the capacitor is connected to the signal line via the switching element; step 3 of, after step 2, forming a passivation layer on the base substrate, and forming passivation layer vias by patterning the passivation layer; and step 4 of, after step 3, depositing a transparent conductive thin film on the base substrate, forming a pixel electrode of each sub-pixel and via connection patterns of each touch-sensitive pixel by patterning the transparent conductive thin film, wherein the pixel electrode is connected to a drain electrode of the TFT in the sub-pixel through one passivation layer via.

A third aspect of the present invention provides a color-filter substrate comprising color filters for different colors, a black matrix and spacers including primary spaces and secondary spacers, wherein, the black matrix includes sensing areas each arranged in opposite to one of the touch-sensitive pixel areas of the array substrate mentioned above and for covering the touch-sensitive pixel areas; the secondary spacers are arranged on the sensing areas of the black matrix and each in opposite to the sensing TFT and the capacitor of one touch-sensitive pixel; a first terminal of each secondary spacer abuts against the black matrix, and a second terminal thereof is opposite to the sensing TFT and the capacitor of the touch-sensitive pixel.

A fourth aspect of the present invention provides a method for manufacturing a color-filter substrate, comprising: forming a black matrix and color filters for different colors on a base substrate, the black matrix including sub-pixel areas and sensing areas, wherein each sub-pixel area includes a light transmission area corresponding to one of the color filters, and sensing areas are opaque areas; forming a planar layer and a common electrode layer on the black matrix and the color filters; and forming secondary spacers in the sensing areas of the black matrix, wherein each secondary spacer is arranged in opposite to the sensing TFT and the capacitor of one touch-sensitive pixel, a first terminal of the secondary spacer abuts against the black matrix, and a second terminal of the secondary spacer is opposite to the sensing TFT and the capacitor of the touch-sensitive pixel.

A fifth aspect of the present invention provides a liquid crystal display including a backlight, an array substrate mentioned above, a color-filter substrate mentioned above, a driving circuit, and spacers arranged between the array substrate and the color-filter substrate that are assembled with facing each other, wherein the spacers include primary spacers and secondary spacers, two terminals of each primary spacer are respectively in contact with the array substrate and the color-filter substrate, and a first terminal of each secondary spacer is arranged on the black matrix and a second terminal of the secondary spacer is opposite to the array substrate but not in contact with the array substrate, each sensing area of the black matrix on the color-filter substrate is arranged in opposite to one touch-sensitive pixel area on the array substrate, and covers the touch-sensitive pixel area; the second terminal of each secondary spacer is arranged in opposite to the sensing TFT and the capacitor of one touch-sensitive pixel; and the driving circuit is used to drive the liquid crystal display, and is connected to the signal lines arranged on the array substrate and used to process electrical signals received from the signal lines to perform a touch addressing.

A sixth aspect of the present invention provides a touch addressing method for the liquid crystal display mentioned above, the method including: scanning the gate lines on the array substrate according to a scanning timing; acquiring an electrical value on each of the signal lines on the array substrate at the time of scanning each row of gate lines; and comparing the value of the electrical signal with a touch occurrence threshold value, judging whether a touch action occurs or not according to a comparison result, and determining coordinates of a touching point when the occurrence of a touch action is determined; the signal line, through the electrical signal of which the occurrence of the touch action is determined, is connected to the capacitor in the touch-sensitive pixel, where the touch action occurs, on the array substrate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a diagram showing a partial top view of a structure of an array substrate provided by a first embodiment of the present invention;

FIG. 2 is a first diagram for the structure of touch-sensitive pixel shown in FIG. 1;

FIG. 3 is a second diagram for the structure of touch-sensitive pixel shown in FIG. 1;

FIG. 4 is a schematic diagram of equivalent circuit corresponding to the touch-sensitive pixel shown in FIGS. 2 and 3;

FIG. 5 is a diagram of a structure for a LCD provided by an embodiment of the present invention;

FIG. 6 is a waveform diagram for the gate line voltage of the array substrate provided by an embodiment of the present invention;

FIG. 7 is a diagram showing the state at the time of non-occurrence of a touch action; and

FIG. 8 is a diagram showing the state at the time of occurrence of a touch action.

### DETAILED DESCRIPTION

To make objects, technical solutions and advantages provided by embodiments of the present invention more clearly, a clear and full description will be made to the technical solutions of embodiments of the present invention hereinafter in connection with the accompanying drawings of present embodiments. Apparently, rather than all the embodiments, embodiments to be described is only a part of embodiments of the present invention. Based on the embodiments of the present invention, all the other embodiments acquired by those skilled in the art without making creative work belong to the scope claimed by present invention.

Hereinafter, with the accompanying drawings, an explanation will be respectively made to the array substrate and the color-filter substrate which each form one substrate of a LCD in two embodiments.

### First Embodiment

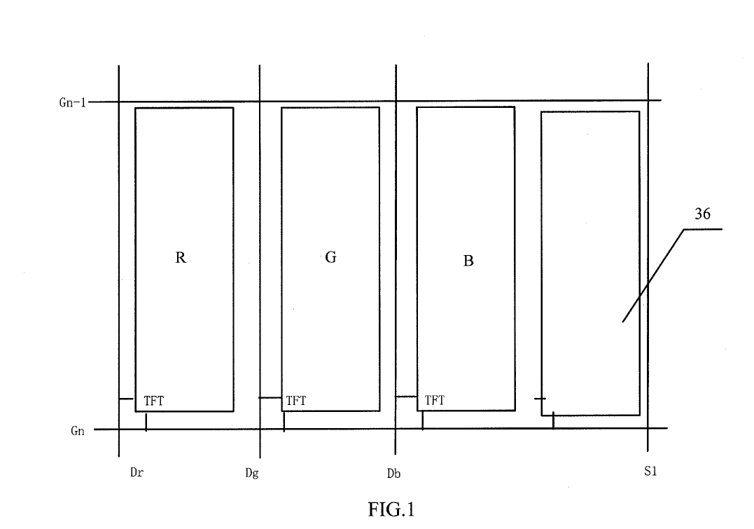

FIG. 1 is a diagram showing a partial top view of a structure of an array substrate provided by a first embodiment of the present invention. In FIG. 1, one of unit pixel regions formed on a base substrate of the array substrate is shown. The array substrate and the color-filter substrate are placed oppositely to form a liquid crystal panel; and on the color-filter substrate, there is arranged a common electrode which forms a liquid crystal capacitor Clc in cooperation with a pixel electrode and the like. The above one unit pixel region comprises three sub-pixels which respectively contain color filters for red, green and blue (R, G and B) colors on the color-filter substrate. These three pixels can be referred to as red sub-pixel, green sub-pixel and blue sub-pixel respectively. In particular, a plurality of sub-pixels, each of which is defined by intersections of the data lines and gate lines, are arranged in a matrix. FIG. 1 shows gate lines of Gn (one of the gate lines, which can be referred to as a first gate line) and Gn−1 (one gate line that is located above and adjacent to the first gate line and can be referred to as a second gate line). Further, there are also shown data lines of Dr, Dg and Db for transporting data signals to the above three sub-pixels respectively. In each of the sub-pixels, there are also arranged a thin film transistor (TFT) as a switching element and a pixel electrode. Further, on the base substrate, there can be formed a common electrode line which extends in parallel to gate lines to provide store capacitance (or auxiliary capacitance).

In this embodiment, in a unit pixel region shown in FIG. 1, a touch-sensitive pixel 36 for sensing a touch action is further arranged, in addition to the three sub-pixels for red, green and blue colors. The touch-sensitive pixel 36 can be arranged for each of the unit pixel regions, so as to increase the sensitivity for sensing a touch action. For example, with a sub-pixel arrangement shown in FIG. 1, the touch-sensitive pixel 36 can be located at a position on a side of the blue sub-pixel, and the region on the color filter substrate and corresponding to the position is covered by the black matrix. Of course, the touch-sensitive pixel 36 can be arranged on a side of the red sub-pixel or the green sub-pixel. Further, it is not necessarily to arrange a touch-sensitive pixel for each of the unit pixel regions on the array substrate, and it is possible to arrange a touch-sensitive pixel for a part of the unit pixel regions depending on the required touching sensitivity.

The specific structure of the touch-sensitive pixel 36 will be explained below. The touch-sensitive pixel 36 can include a sensing thin film transistor (TFT), a capacitor, a switching element and a signal line. A first terminal of the capacitor is connected to the drain electrode of the sensing TFT, and a second terminal thereof is connected to a first gate line which is one of the gate lines of the array substrate. The gate electrode of the sensing TFT is connected to the first gate line; the source electrode thereof is connected to a charging power supply. The switching element is connected between the first terminal of the capacitor and the signal line. The signal line is used to output the voltage at the first terminal of the capacitor to a driving circuit which judges that a touch action occurs when the voltage at the first terminal is increased.

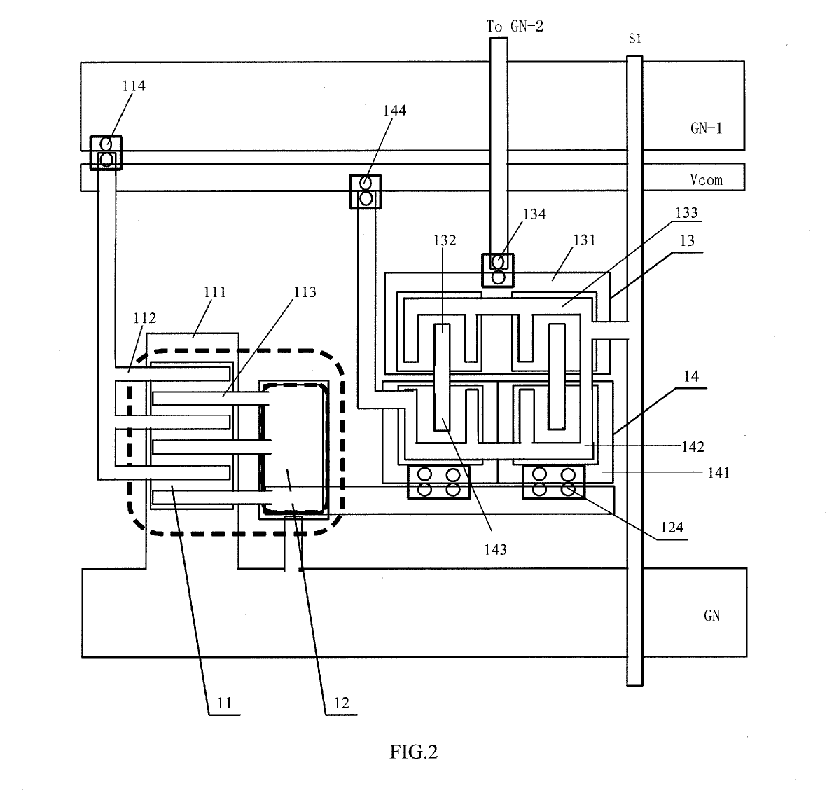

Hereinafter, taking a switching element comprising a first TFT 13 and a second TFT 14 as an example, an explanation will be made to a structure of the touch-sensitive pixel in connection with FIG. 2. FIG. 2 shows a first diagram for the structure of touch-sensitive pixel 36 shown in FIG. 1. As shown in FIG. 2, on the base substrate of the array substrate, there are formed the gate lines of Gn, Gn−1 and Gn−2 (one gate line that is located above the first gate line, spaced by one gate line therefrom and can be referred to as a third gate line) and a common power supply line Vcom which extend in parallel, a plurality of gate electrodes, and a second terminal of a capacitor 12 that is connected to the first gate line Gn. Here, these gate electrodes comprise gate electrode 111 of a sensing TFT 11 that is connected to the first gate line Gn, the gate electrode 131 of a first TFT 13 and the gate electrode 141 of a second TFT 14. On the respective gate lines and gate electrodes, a gate insulation layer, a semiconductor layer islands and a data line metal thin film layer are sequentially formed. The data line metal thin film layer is patterned to form data lines, the source and the drain electrodes of the respective TFTs, a signal line S1 and the first terminal of capacitor 12, and the signal line S1 is arranged in parallel to the data lines of Dr, Dg and Db. Further, three TFTs formed by the semiconductor layer islands, the source electrodes, the drain electrodes and the gate electrodes within the touch-sensitive pixel include the sensing TFT 11, the first TFT 13 and the second TFT 14. The drain electrode 113 of the sensing TFT 11 is connected to the first terminal of the capacitor 12. On the data line metal thin film layer, there is formed a passivation layer and a passivation layer via which can be used for connection between circuits at different layers. Of the first TFT 13, the gate electrode 131 is connected to the third gate line Gn−2 through a via 134, the source electrode 132 is connected to the drain electrode 143 of the second TFT 14, and the drain electrode 133 is connected to the signal line S1. Of the second TFT 14, the source electrode 142 can be connected to a first power (for example, a common electrode line Vcom) through a via 144, and the gate electrode 141 is connected to the first terminal of the capacitor 12 through a via 124. The source electrode 112 of the sensing TFT 11 is connected to the second gate line Gn−1 through a via 114. On the passivation layer, there is formed a pixel electrode layer, and this pixel electrode layer is patterned to form connection patterns for connecting the vias.

Further, the source and drain electrodes of the sensing TFT 11, the first TFT 13 and the second TFT 14 with the above structure can be of a comb structure. The arrangement of this comb structure can increase a ratio of width to length of the channels, so that an electric current can be transferred more sensitively and effect of sensing a touch action is improved.

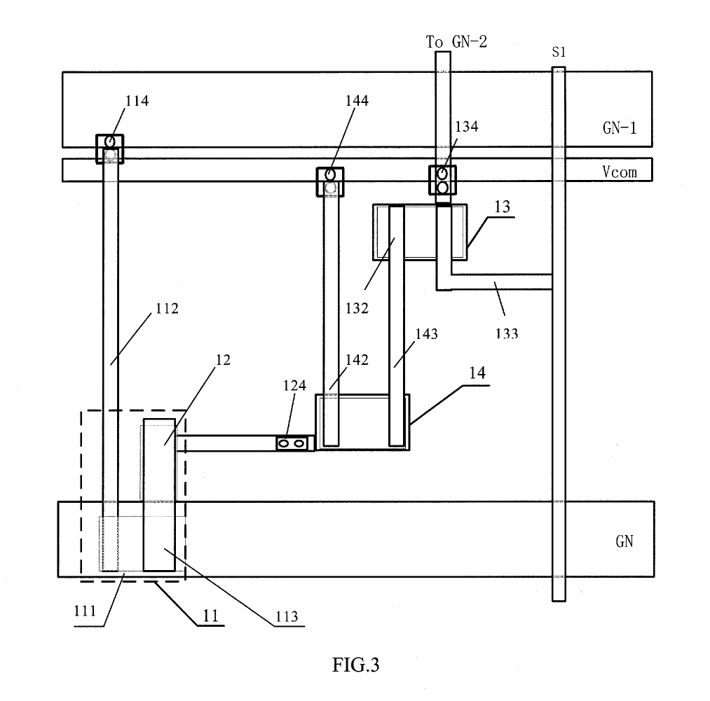

It can be understood by those skilled in the art that, the touch-sensitive pixel of this embodiment can also be made in other structures. For example, FIG. 3 is a second diagram for a structure of the touch-sensitive pixel shown in FIG. 1, which employs a conventional structure and is roughly similar to the structure shown in FIG. 2, except that the source and drain electrodes of the TFTs 11, 13 and 14 in the touch-sensitive pixel are of a structure other than the comb structure.

It should be noted that, it can be understood by those skilled in the art that, the above structure is only one implementation of the touch-sensitive pixel, and the invention is not limited thereto. The exemplified illustration is as follows. The charging power supply to which the sensing TFT 11 is connected can be other power supply lines instead of the second gate line Gn−1. For example, one power supply line can be additionally arranged on the array substrate that is positioned on a side of the touch-sensitive pixel, and connected to the source electrode 112 of the sensing TFT 11. In comparison, the mode in which the second gate line Gn−1 is used can not only make the structure of the array substrate simpler, but also make the manufacture steps simplified. Likewise, it is also possible to use other devices for the switching element and the first power supply, as long as it is capable of serving as a corresponding power supply or switching element.

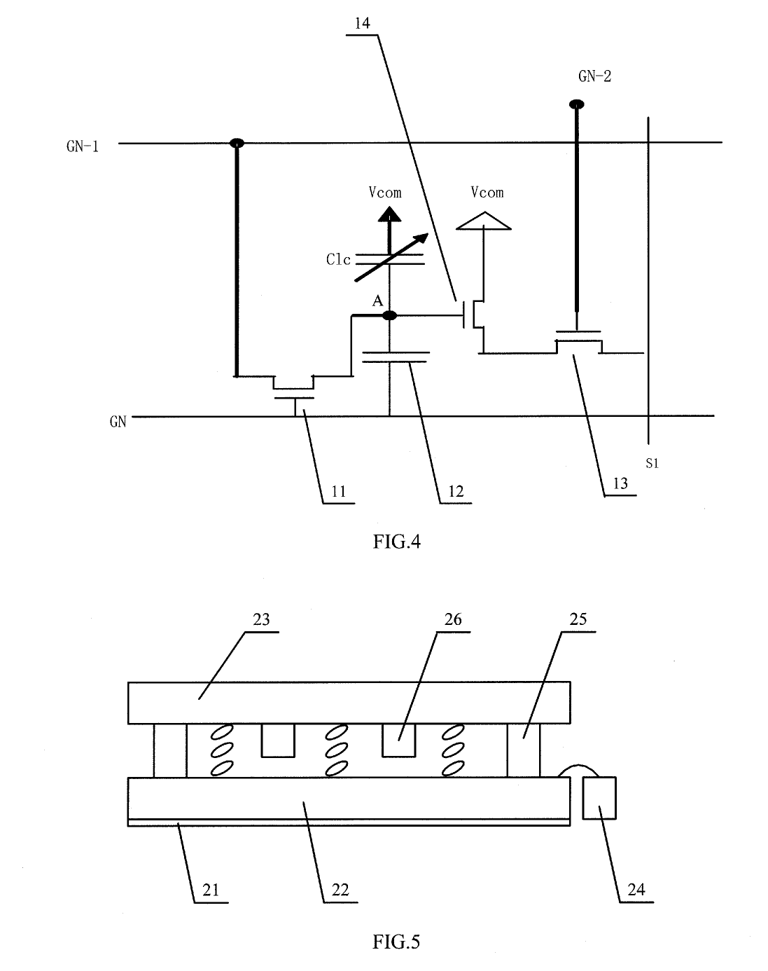

Hereinafter, the principle for sensing a touch action by the array substrate with above structure will be explained in detail in connection with FIG. 4. FIG. 4 is a schematic diagram of equivalent circuit corresponding to the touch-sensitive pixel shown in FIGS. 2 and 3, and the connection of the circuit thereof has been explained above. The capacitor 12 and the liquid crystal capacitor Clc are serially connected between the common electrode line on the color-filter substrate and the first gate line Gn. The lower plate of the liquid crystal capacitor Clc is constituted by the first terminal of the capacitor 12 or connected thereto, and the upper plate thereof is constituted by the common electrode on the color-filter substrate that is opposite to the first terminal of the capacitor 12.

Where no touch action occurs, when a gate scanning signal is applied to the first gate line Gn, the sensing TFT 11 is turned on and the capacitor 12 is charged, and the potential at point A of the first terminal of capacitor 12 becomes elevated. Since the second TFT 14 is arranged so that the turn-ON voltage thereof corresponds to a touch state, and at this time, the voltage at the first terminal of the capacitor 12 is lower than the turn-ON voltage of the second TFT 14, the second TFT 14 is turned off. After the gate line signal scanning completes, the potential at the first terminal A of the capacitor 12 is maintained. When the gate scanning signal is applied to the third gate line Gn−2 in a next frame, the first TFT 13 is turned on. Since the voltage at point A is lower than the turn-ON voltage of the second TFT 14, no current will flow from the drain electrode 133 of the first TFT 13 to the signal line S1.

Where a touch action occurs, due to the touching, the gap between the array substrate and the color-filter substrate is reduced and the liquid crystal capacitor Clc becomes larger; whereas the liquid crystal capacitor Clc and the capacitor 12 on the array substrate are connected in series such that the divided voltage over the liquid crystal capacitor Clc becomes smaller. Therefore, the voltage of point A at this time is higher than the voltage of point A at the time of non-occurrence of the touch, and the construction of the touched pixel is arranged such that the voltage of point A at this time is boosted to be higher than the turn-ON voltage of the second TFT 14. Hence the second TFT 14 is turned on, and if the first TFT 13 is also turned on, a current is allowed to be outputted from drain electrode 133 of the first TFT 13. When no current is received by the driving circuit (not shown) connected to the signal line S1, it is judged that a touch action does not occur; and when a current is received by the driving circuit connected to the signal line S1, it is judged that a touch action occurs. Here, the driving circuit senses a touch action according to whether there is a current or not.

Further, in the above FIGS. 2 and 3, the switching element comprising two TFTs is taken as an example, and the switching element can also include the first TFT 13 only. Of the first TFT 13, the source electrode 132 can be connected to the first terminal of capacitor 12, and the drain electrode 133 can be connected to the signal line S1 which outputs an electrical signal at the first terminal of the capacitor 12 to the signal line S1 so as to be analyzed and judged. For example, the gate electrode 131 of the first TFT 13 can be connected to the third gate line Gn−2. When a gate scanning signal is applied to the first gate line Gn, the sensing TFT is turned on and the capacitor is charged, thus the potential at the first terminal of the capacitor becomes elevated. After the gate line signal scanning completes, the potential at the first terminal of the capacitor is maintained. When the gate scanning signal is applied to the third gate line Gn−2 in a next frame, the first TFT is turned on, and a current flows from the source electrode that is connected to the first terminal of the capacitor 12 to the drain electrode that is connected to the signal line. The voltage at the first terminal of the capacitor at the time of occurrence of a touch becomes higher than that of the capacitor at the time of non-occurrence of a touch action. Accordingly, the current on the signal line at the time of occurrence of a touch action is higher than the current on the signal line at the time of non-occurrence of a touch action. The driving circuit judges whether a touch action occurs or not in accordance with a magnitude of received current on the signal line.

The array substrate according to this embodiment can detect the occurrence of a touch action by additionally arranging a touch-sensitive pixel; and in contrast to the structure in which a film is attached outside of the liquid crystal panel, the structure of the array substrate become simpler, the liquid crystal panel is not increased in thickness and weight, and the cost can be reduced. Also, display quality of the liquid crystal panel can be significantly improved.

### Second Embodiment

The array substrate according to the first embodiment can be fabricated with an array substrate manufacture method provided of the second embodiment, so as to form a corresponding pattern structure. Hereinafter, this method is exemplified with following steps. The pattern formation in each of the steps can include processes such as thin film deposition, photoresist coating, photoresist exposing and developing, etching, stripping and the like. In a specific implementation, the layers of the touch-sensitive pixel can be formed along with the respective layers of the sub-pixels (red, green and blue sub-pixels) for display. The fabrication process for the array substrate is not limited to the process such as three, four or five-mask process and the like, which can be selectively adopted by those skilled in the art. The exemplary method comprises the steps as follows.

At step 101, a gate metal thin film is deposited on a base substrate, and a pattern including the gate lines, the common electrode lines, the gate electrodes and the second terminals of the capacitors of touch-sensitive pixels is formed by etching the gate metal thin film by a patterning process, the gate electrodes including the gate electrodes of the sensing TFTs.

At step 102, the gate insulation layer, the semiconductor layer thin film and the data line metal thin film are formed on the base substrate on which the above pattern is formed; a pattern including data lines, the source and the drain electrodes of respective TFTs and the semiconductor layer islands and a pattern of signal lines and the first terminals of the capacitors are formed by etching the data line metal thin film and the semiconductor layer thin film with a patterning process. For example, in this embodiment, the signal line pattern can be formed along with the data lines and the like on a same layer.

The TFTs, which comprise TFTs of sub-pixels and the sensing TFTs of the touch-sensitive pixels, is formed by the gate electrodes, the source electrodes, the drain electrodes and the semiconductor layer islands. Each sensing TFT is formed in one touch-sensitive pixel. The gate metal thin film and the data line metal thin film are overlapped in each touch-sensitive pixel to form a capacitor. The second terminal of the capacitor is connected to the first gate line Gn of the gate lines with respect to the touch-sensitive pixel; the gate electrode of the sensing TFT is also connected to the first gate line Gn, the source electrode thereof is connected to a charging power supply, and the drain electrode thereof is connected to the first terminal of the capacitor; the first terminal of the capacitor is connected to the signal line through the switching element.

Further, the switching element of one above touch-sensitive pixel can comprise two TFTs. In this case, the TFTs formed in the above steps can include a first TFT and a second TFT. The gate electrodes of the two TFTs can be formed in simultaneous with the formation of gate electrode of the sensing TFT in step 101. The gate electrode of the second TFT is connected to the first terminal of the capacitor, the source thereof is connected to a first power supply which for example can be a common electrode line Vcom, and the drain electrode thereof is connected to the source electrode of the first TFT. The drain electrode of the first TFT is connected to the signal line, and the gate electrode thereof can be connected to the third gate line Gn−2. The source electrode of the sensing TFT can be connected to the second gate line Gn−1 as the charging power supply.

Further, the switching element of one above touch-sensitive pixel also can be one TFT only. At this time, the TFT formed in this step can comprise the first TFT of which the source electrode is connected to the first terminal of the capacitor, the drain electrode is connected to the signal line, and the gate electrode is connected to the third gate line Gn−2. That is, a change in voltage at the first terminal of the capacitor can be directly transferred to the signal line through the first TFT.

Also, in the above step, the material for forming the gate lines, the data lines, the source and the drain electrodes of the TFTs, the common electrode lines can be of a single layer or multi-layer structure that is formed of one selected from aluminum, chromium, tungsten, copper, tantalum, titanium, molybdenum, and nickel-aluminum or any combination thereof. The gate lines and the common electrode lines may be formed of a same material and fabricated in the same processes of coating, lithography and etching. The gate insulation layer may be formed of a material such as silicon nitride or aluminum oxide. Etching process may be a dry etching method or a wet etching method (such as chemical corrosion).

The method of directly taking the gate lines as corresponding power supply lines and adopting TFTs as switching elements makes the process relatively simple since there is not necessary to add an additional step of etching process to the procedure of the manufacture of the array substrate.

At step 103, a passivation layer is formed on the base substrate on which the above pattern is formed, and a pattern of passivation layer vias is formed by etching the passivation layer by a patterning process.

The passivation layer is formed on the gate insulation layer, the data lines and the TFTs, and the passivation layer vias formed as described above can be used for connection of the circuit patterns on different layers. For example, when a switching element of one touch-sensitive pixel comprises two TFTs, the passivation layer vias can include a connection via 114 between the source electrode of the sensing TFT and the second gate line Gn−1, a connection via 144 between the source electrode of the second TFT and the common electrode line, a connection via 124 between the gate electrode of the second TFT and the first terminal of the capacitor, and a connection via 134 between the gate electrode of the first TFT and the third gate line Gn−2 and the like. Further, it is also possible to form a via (not shown) for connection with pixel electrode on the drain electrodes of the second TFT.

At step 104, a transparent conductive thin film is deposited on the above pattern, a pixel electrode of each sub-pixel and a via connection pattern of each touch-sensitive pixel are formed by etching the transparent conductive thin film by a patterning process.

The material for the transparent conductive thin film can be a transparent conductive material such as indium tin oxide, indium zinc oxide, zinc aluminum oxide or the like. With this step, the transparent conductive thin film can be patterned to form the connection line for the vias, and the connection between the conductive patterns on different layers described in step 103 is achieved.

By forming respective elements of touch-sensitive pixel in the procedure of manufacture of the array substrate, the array substrate manufacture method according to this embodiment can achieve the touch function and simplify the process without an additional etching process; and it is not necessary to attach the touch film layer to the outside of a LCD panel, thus the touch screen is made lighter and thinner, display quality is improved, and manufacturing cost is reduced.

### Third Embodiment

The embodiment of the present invention also provides a color-filter substrate which can comprise color filters for red, green and blue colors, a black matrix and spacers.

In particular, the black matrix includes sub-pixel areas and sensing areas. The sub-pixel areas correspond to respective sub-pixel areas on the array substrate, and have red, green and blue color filters, cooperating with the sub-pixel areas on the array substrate to display. The sensing areas are arranged in opposite to the touch-sensitive pixel areas on the array substrate and cover the touch-sensitive pixel areas after assembling, thus light from a backlight is prevented from leaking from the touch-sensitive pixel areas. The spacers may comprise primary spacers and secondary spacers. A first terminal of each secondary spacer abuts against the black matrix, and a second terminal thereof is opposite to the sensing TFT and the capacitor in a touch-sensitive pixel area, but not in contact with them.

Further, the surface of the second terminal of each secondary spacer can be further provided with a reflection layer for reflecting the light from a backlight to the sensing TFT. The reflection layer can be formed of a material such as copper, aluminum or any alloy thereof.

Hereinafter, a detailed explanation will be made on the improvement of the structure for a secondary spacer. One secondary spacer can be arranged in opposite to the sensing TFT and the capacitor of a touch-sensitive pixel that is arranged on the array substrate. After the assembly of the array substrate and the color-filter substrate, the array substrate serves as a lower substrate, and the color-filter substrate serves as an upper substrate. Then, the position where the secondary spacer is located is above the sensing TFT and the capacitor, but not in contact with them. Further, on the surface opposite to the sensing TFT and the capacitor, one reflection layer from which light can be reflected may be deposited by sputtering and etching, and the reflection layer can be formed of copper, aluminum, any alloy thereof or the like that allow of light reflection, and is used to reflect the light from the backlight to the sensing TFT on the array substrate, so that the sensing TFT can operate in an illumination state. In formation, a sputtering process and an etching process are further added to the manufacturing procedure of the color-filter substrate. Also, this reflection layer can be connected to the common electrode line formed on the color-filter substrate, and a voltage of Vcom is applied to the common electrode line and thus is transferred to the reflection layer, so that the voltage of the reflection layer is also equal to Vcom.

By arranging, on the black matrix, the sensing areas that are opposite to and cover the touch-sensitive pixel areas on the array substrate, the color-filter substrate according to this embodiment can be used to achieve the touch function.

### Fourth Embodiment

A color-filter substrate manufacture method according to the present invention, which can be used to manufacture the color-filter substrate described in the third embodiment, comprises the following steps.

At step 201, a black matrix is formed on the base substrate by a process, for example, including sputtering or depositing of a black matrix material layer, patterning of the layer, and the like.

Here, the black matrix includes sub-pixel areas and sensing areas. The sensing areas are arranged in opposite to the touch-sensitive pixel areas on the array substrate and cover the touch-sensitive pixel areas after the assembly of the array substrate and the color-filter substrate. The sub-pixel areas correspond to sub-pixel areas on the array substrate for display, and these sub-pixel areas are exposed for allowing light pass.

At step 202, the color filters for red, green and blue colors are sequentially formed by repeating three times the processes of forming a color resin film, patterning the film, and the like. The color filters for red, green and blue colors correspond to sub-pixel areas on the black matrix.

Here, the sequence of forming the color filters for red, green and blue and of forming the black matrix can be exchanged.

At step 203, a planar layer is formed on the structure formed in the step 202.

At step 204, an ITO layer, primary spacers and secondary spacers are sequentially formed on the planar layer.

Here, a first terminal of one primary spacer is in contact with the black matrix, and a second terminal thereof is in contact with the array substrate after the assembly of the color-filter substrate and the array substrate. The primary spacers can be arranged on the color-filter substrate or arranged on the array substrate before the assembly. The secondary spacers are arranged in the sensing areas of the black matrix, and preferably each in opposite to the sensing TFT and the capacitor in one touch-sensitive pixel on the array substrate. A first terminal of one secondary spacer is arranged on the surface of the black matrix and connected thereto, and after the assembly of the color-filter substrate and the array substrate, a second terminal thereof is arranged in opposite to the sensing TFT and the capacitor in one touch-sensitive pixel, but is not in contact therewith. Further, to improve the touch sensitivity, it is preferable to proceed to step 205.

At step 205, a reflection metal layer is deposited on the color-filter substrate which has the secondary spacers formed thereon, and then a reflection layer on the top of the secondary spacers is formed with a lithography process.

Thus, the reflection layer on the surfaces of the second terminals of the secondary spacers is formed by adding the process of film forming and etching to the manufacture process of the color-filter substrate, and form. The reflection layer is used to reflect the light from the backlight to the sensing TFT of a touch-sensitive pixel on the array substrate. The reflection layer can be formed of copper, aluminum, any alloy thereof or the like that allows of light reflection.

By arranging, on the black matrix, the sensing areas that are opposite to the touch-sensitive pixel areas on the array substrate, it is possible for the color-filter substrate manufacture method according to this embodiment to achieve the touch function.

### Fifth Embodiment

FIG. 5 is a diagram of a structure for a LCD provided by an embodiment of the present invention. As shown in FIG. 5, this LCD can comprise a backlight 21, an array substrate 22, a color-filter substrate 23 and a driving circuit 24. Here, the array substrate 22 and the color-filter substrate 23 are assembled facing each other; between the array substrate 22 and the color-filter substrate 23, there are arranged spacers 25, 26 for supporting the height or gap between the substrates. The spacers 25, 26 can be of a shape such as round, square or others. The spacers 25, 26 are arranged against the black matrix on the color-filter substrate 23, and include primary spacers 25 in contact with the array substrate 22 and secondary spacers 26 not in contact with the array substrate 22; the height of the secondary spacers 26 is smaller than that of the primary spacers 25.

The array substrate 22 employs the array substrate structure as described in the first embodiment in which the touch-sensitive pixels are arranged on the array substrate, and the detailed description can be referred to the first embodiment, thus omitted here for simplicity. On the other hand, regarding the color-filter substrate, for example, sensing areas can be arranged on the black matrix, and further, on the surface of the secondary spacers 26 that is opposite to the array substrate, a reflection layer which can perform specular or diffuse reflection of light is provided, and this can be referred to the third embodiment. In a still further aspect, a LCD the driving circuit 24 for a touch processing function can be incorporated and arranged outside of the array substrate 22 and the color-filter substrate 23 so as to scan and drive the LCD, and this circuit 24 can be connected to the signal lines arranged on the array substrate 22 so as to process the electrical signals received from the signal lines to achieve touch addressing.

In particular, the sensing areas of the black matrix on the color-filter substrate are arranged in opposite to the touch-sensitive pixel areas on the array substrate, and cover the touch-sensitive pixel areas; each of the secondary spacers on the color-filter substrate is arranged in opposite to the sensing TFT and the capacitor of one touch-sensitive pixel. That is, after the assembly of the array substrate 22 and the color-filter substrate 23, the array substrate 22 serves as a lower substrate, and the color-filter substrate 23 serves as an upper substrate. Then, each of the secondary spacers 26 is positioned above the sensing TFT and the capacitor but not in contact with them.

Hereinafter, an exemplary structure of a LCD shown in FIG. 5 is described, in which a reflection layer is arranged on a lower surface of secondary spacers on the color-filter substrate and opposite to the array substrate, and the principle of the LCD of present embodiment sensing a touch event will be explained in connection with the exemplary structure. Further, the circuit diagram of this embodiment can be referred to FIG. 4. Here, as described in the first embodiment, a touch event can be sensed by a change in voltage at point A, except that a reflection layer is arranged on the surface of the secondary spacers, which can further enhance the degree of the change in the voltage at point A and improve the sensitivity of sensing a touch action by means of the photosensitivity of the sensing TFT.

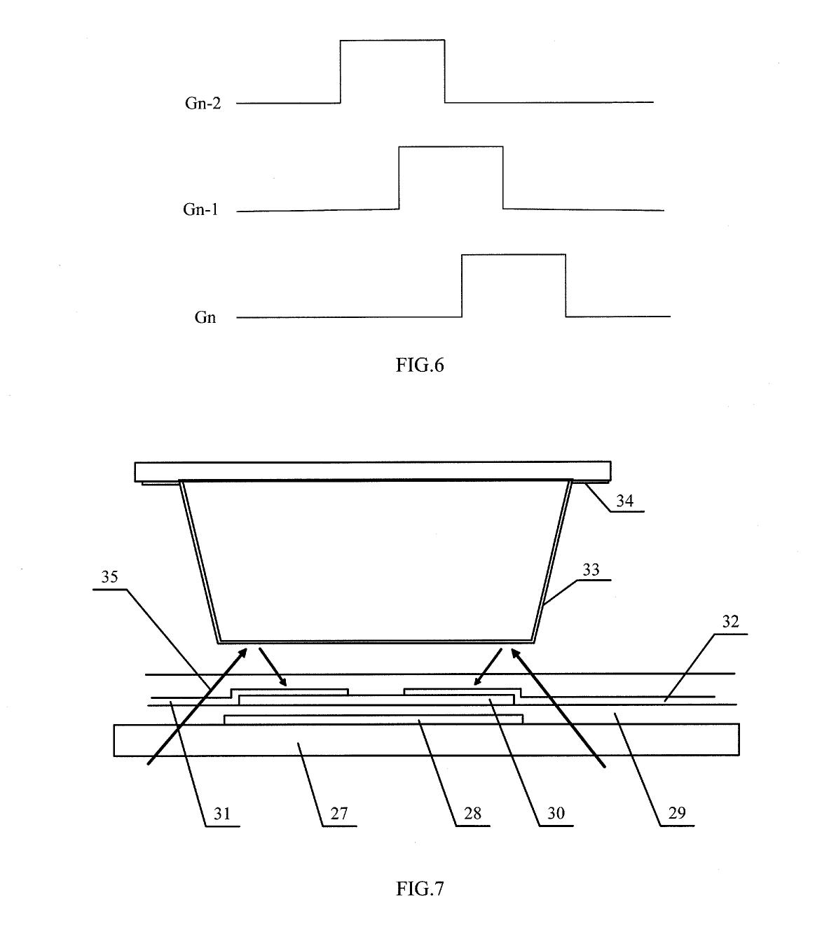

First, since touch-sensitive pixels are formed on the array substrate, the gate lines Gn, Gn−1 on the array substrate transmit the gate driving signals. This embodiment can employ the gate driving signals in pre-charge manner, and a specific waveform thereof can be referred to FIG. 6. FIG. 6 is a waveform diagram for the gate line voltage of the array substrate provided by an embodiment of the present invention. The gate driving signals in pre-charge manner give rise to a certain temporal overlap between the ON voltages for two adjacent gate lines. In particular, as shown in FIG. 6, the gate lines are scanned to be turned on at a certain timing sequence, and there is an overlap between the ON periods for two adjacent gate lines. For example, the second gate line Gn−1 is turned on, and the first gate line Gn adjacent thereto can be turned on when the turn-ON period of the second gate line Gn−1 has not completed yet, thus the tail of the turn-ON period for the second gate line Gn−1 is partly overlapped with the starting portion of the turn-ON period for the first gate line Gn.

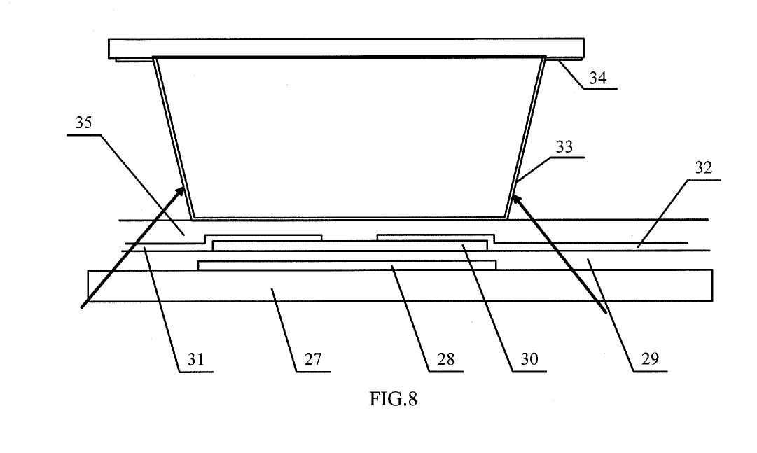

FIGS. 7 and 8 show a sectional structure of a part of the array substrate and one sensing TFT. The array substrate includes a base substrate 27, a gate line 28, a gate insulation layer 29, a semiconductor layer island 30, a source electrode 31 and a drain electrode 32 etc, and the semiconductor layer island 30, the source electrode 31, the drain electrode 32 and the gate electrode constitute the sensing TFT. The reflection layer 33 deposited on the surface of one secondary spacer 26 is connected to the common electrode line 34 formed on the color-filter substrate 23.

FIG. 7 is a diagram showing the state at the time of non-occurrence of a touch action. As shown in FIG. 7, when there is no pressure applied on a surface of the liquid crystal panel (that is, at the time of non-occurrence of a touch action), the surface of the secondary spacer 26 and the sensing TFT on the array substrate are not in contact, and there is a certain distance therebetween. The reflection layer 33 can reflect the light 35 emitted from a backlight to the sensing TFT, so that the sensing TFT is allowed to operate in an illumination state. The first gate line Gn can turn on the sensing TFT 11, and when the first gate line Gn is just turned on, there is an overlapped driving period between the first gate line Gn and the second gate line Gn−1, then the sensing TFT 11 having been turned on can charge the point A at one terminal of capacitor 12, that is, the voltage at point A at one terminal of the coupling capacitor 12 is elevated to a certain value. When the second gate line Gn−1 is at the falling edge, the sensing TFT 11 can discharge the above point A to a certain value or extent. The exact numerical value of this discharge depends on characteristics of the sensing TFT 11 such as the magnitude of the drain current of the sensing TFT 11. In addition, since the point A at one terminal of the capacitor 12 is connected to the gate electrode of the second TFT 14, the voltage at point A can allow the second TFT 14 to be turned on (in a conductive state), and a current can be outputted from the drain electrode of the second TFT 14. When the third gate line Gn−2 is turned on in a next frame, the first TFT 13 will be turned on, and the drain current from the second TFT 14 can be outputted form the first TFT 13 to the signal line S1, then the signal line S1 outputs this current to a driving circuit connected thereto.

FIG. 8 is a diagram showing the state at the time of occurrence of a touch action. As shown in FIG. 8, when there is a press action (that is, touch) on the surface of the liquid crystal panel, the surface of the liquid crystal panel will be bent downward, that is, the distance between the color-filter substrate 23 and the array substrate 22 will be narrowed, so that the secondary spacer 26 at the touching position will cover the sensing TFT in the corresponding touch-sensitive pixel on the array substrate. This coverage can be in contact with the array substrate or not, as long as the reflection layer 33 on surface of the secondary spacer 26 cannot reflect the light from the backlight to the sensing TFT any more. At this time, the operation of the sensing TFT is changed from an illumination state to a dark state. According to the light characteristics of a TFT, in the illumination state, the ON-state current of the TFT will be approximately increased by 50% than that in the dark state, while OFF-state current will be increased by 1.5 or more times than that in the dark state. At the time of occurrence of a touch action, the sensing TFT 11 is changed into the dark state, the OFF-state current will be decreased greatly, and the voltage at point A during the turn-ON period of the first gate line after charge is reduced as compared with that in the illumination state. In addition, at the time of occurrence of a touch action, the liquid crystal capacitor Clc will be increased in its capacitance and decreased in its voltage division, which also makes the voltage at point A higher. Thus it is possible to significantly reduce the discharge voltage of point A at one terminal of the capacitor 12 by the sensing TFT 11, and the voltage at point A will be higher than the voltage at the time of non-occurrence of a touch action. After the first gate line is turned off, the sensing TFT 11 is switched off, and the voltage at point A is maintained. When the third gate line Gn−2 is turned on in a next frame, since the voltage at point A serves as the gate voltage of the second TFT 14, a significant increase in voltage at point A will cause a significant increase in the drain current of the second TFT 14, the drain current of the second TFT 14 can be outputted from the first TFT 13 to the signal line S1, and, in turn, this current can be further outputted from the signal line S1 to a driving circuit connected thereto.

After receipt of the current signal transferred from the signal line S1, the driving circuit 24 can perform an analysis processing on the signal to obtain a touch result. Here, the driving circuit 24 may include an amplifying unit and a comparison unit. The amplifying unit is connected to the signal line S1 arranged on the array substrate, and can be used to amplify the current signal received from the signal line S1. The comparison unit is connected to the amplifying unit, and can be used to compare the amplified current signal with a reference signal stored in advance, so as to obtain a touch result. In particular, a timing control member may be further provided in the driving circuit 24, and this member can determine, from a gate line scanning timing, which gate line is turned on at the time of occurrence of a touch even. For example, it is detected and obtained that the third gate line Gn−2 is turned on at the time of occurrence of a touch action, then the position of the pixel unit on which the touch action occurs can be obtained from the array connection structure, that is, it can be obtained that the touch action occurs to a pixel unit between the first gate line Gn and the second gate line Gn−1, then the coordinate where the first gate line Gn is located can be taken as the Y axis coordinate of the touching point. In addition, it is also possible to detect and obtain the signal line of which the current is changed, and take the coordinate where this signal line is located as the X axis coordinate of the touching point. Thus the exact position of the touching point can be obtained in the coordinates of X and Y axes.

By additionally arranging the touch-sensitive pixels on the array substrate and arranging a driving circuit, the LCD of this embodiment integrate a touch function into its liquid crystal panel. In contrast to the conventional structure in which a touch function film is attached onto the outside of the liquid crystal panel, the structure of the LCD according to this embodiment is simpler and does not increase the liquid crystal panel in thickness and weight, and manufacturing cost can be decreased. Also, display quality of the liquid crystal panel can be significantly improved.

### Sixth Embodiment

A touch addressing method according to an embodiment of the present invention can be achieved with the LCD described in the fifth embodiment, and a specific flow thereof can be referred to the above-described touching principle for the LCD. The method can include the following steps.

At step 301, the gate lines on the array substrate are scanned according to a scanning timing; and an electrical signal value on each of the signal lines is acquired when each row of the gate lines is scanned.

This step can be performed as follows. The gate electrode of the sensing TFT of a touch-sensitive pixel is connected to the first gate line with respect to this touch-sensitive pixel, the source electrode thereof is connected to the second gate line, and the second gate line is positioned before the first gate line and adjacent to the first gate line; the first gate line and the second gate line are sequentially scanned in a pre-charge manner. When the first gate line connected to the gate electrode of the sensing TFT is scanned, the sensing TFT is turned on. Since in the pre-charge manner the second gate line is also turned on, that is, when the first gate line Gn is turned on, the second gate line is also turned on, and the turn-on periods of the first gate line and the second gate line are partially overlapped, then a sensed point, which is located between the liquid crystal capacitor and the capacitor which are connected in series and serves as a voltage-division point, can be charged during this overlapping period through the drain electrode of the sensing TFT.

The change in the voltage of the sensed point can be outputted to the signal line. Alternatively, the sensed point can also serve as a gate controlling point for the second TFT, thus the change in the voltage of the sensed point can be converted into the change in the drain current of the second TFT.

At step 302, the obtained electrical signal value is compared with a touch occurrence threshold value, and it is judged whether a touch occurs or not according to the comparison result; coordinates of the touching point are determined when the occurrence of a touch action is determined. The signal line, the electrical signal value of which is changed, is connected to the capacitor in the touch-sensitive pixel on the array substrate to which a touch action occurs.

For example, if the electrical signal value is lower than the touch occurrence threshold value, it is judged that a touch action does not occur to the substrate. If the electrical signal value is higher than or equal to the touch occurrence threshold value, it is judged that a touch action occurs to the panel, and coordinates of the touching point are determined.

If the drain current of the second TFT is transported to the signal line, the first TFT, of which the source electrode is connected to the drain electrode of the second TFT and the drain electrode is connected to the signal line, can be arranged. It is possible to turn on the first TFT and transport the drain current of the second TFT to the signal line.

The electrical signal can be transported to the touch processing unit through the signal line. The touch processing unit can compare the value of the obtained electrical signal with the touch occurrence threshold value. If the value of the electrical signal is lower than the touch occurrence threshold value, it is judged that a touch action does not occur to the panel. If the value of the electrical signal is higher than or equal to the touch occurrence threshold value, it is judged that a touch action occurs to the panel, then at this time, the coordinates of the touching point can be obtained according to the gate line scanned at the time of touching and the signal line that the electrical signal occurs.

The abscissa axis of the touching point can be obtained from the signal line on which the electrical signal occurs, and the ordinate axis of the touching point can be obtained from the gate line scanned at the time of occurrence of a touch action. For example, according to the gate line scanning timing, the timing controlling member of the liquid crystal circuit can detect and obtain a gate line which is turned on at the time of occurrence of a touch action. For example, the timing controlling member of the liquid crystal circuit detects and obtains that the third gate line Gn−2 is turned on at the time of occurrence of a touch action. Then, according to the array connection structure, the position of the touched pixel unit can be obtained, that is, it can be obtained that the pixel between the first gate line Gn and the second gate line Gn−1 is touched, then the coordinate of the first gate line Gn is taken as the Y axis coordinate of the touching point (that is, longitudinal coordinate). Further, the signal line, the current of which is changed, can be detected and obtained, and the coordinate of this signal line can be taken as the X axis coordinate of the touching point (that is, abscissa coordinate). Thus the exact position of the touching point can be obtained through the X and Y axes.

By obtaining the coordinates of the touching point from the gate line scanned at the time of a touch action and the signal line on which the electrical signal occurs, the touch addressing method of the present embodiment achieves a judgment of the touch action, which is very convenient.

Finally, it should be explained that, the above embodiments are only used for explaining the technical solution of the present invention, and not for limitation thereto. Although the present invention has been explained in details with reference to the preferred embodiments, it should be understood by those skilled in the art that modifications and equivalent alternations may be made to the technical solution of the present invention, and these modifications and equivalent alternations can not depart the modified technical solution from the spirit and scope of the technical solution of the present invention.

What is claimed is:

1. An array substrate including:
a base substrate;
gate lines and data lines on the base substrate;
sub-pixels defined by intersections of gate lines and data lines and used for display; and
touch-sensitive pixels also defined by intersections of gate lines and data lines and each comprising a sensing thin film transistor (TFT), a capacitor, a switching element and a signal line;
wherein, for each touch-sensitive pixel, the capacitor is formed by overlapping a gate metal thin film for forming the gate lines and a data line metal thin film for forming the data lines on the base substrate, a first terminal of the capacitor is connected to a drain electrode of the sensing TFT, a second terminal of the capacitor is connected to a first gate line which is one of the gate lines and corresponds to a row where the touch-sensitive pixel is located, and a voltage at the first terminal of the capacitor at the time of occurrence of a touch action is higher than that of the capacitor at the time of non-occurrence of a touch action;
the sensing TFT, of which a gate electrode is connected to the first gate line and a source electrode is connected to a charging power supply, is used to charge the capacitor when the first gate line is turned on;
the switching element is connected between the first terminal of the capacitor and the signal line, and is used to output the voltage at the first terminal to the signal line; and
the signal line is used to output the voltage at the first terminal to a driving circuit which judges the occurrence of the touch action from an increase of the voltage at the first terminal.

2. The array substrate according to claim 1, wherein the switching element comprises a first TFT;
the gate electrode of the first TFT is connected to a third gate line which is one of the gate lines before the first gate line and is arranged to be spaced from the first gate line by one gate line, the source electrode of the first TFT is connected to the first terminal of the capacitor, and the drain electrode of the first TFT is connected to the signal line.

3. The array substrate according to claim 1, wherein the switching element comprises a first TFT and a second TFT;
the gate electrode of the first TFT is connected to a third gate line which is one of the gate lines before the first gate line and is arranged to be spaced from the first gate line by one gate line, the source electrode of the first TFT is connected to the drain electrode of the second TFT, and the drain electrode of the first TFT is connected to the signal line; and
the source electrode of the second TFT is connected to a first power supply, and the gate electrode of the second TFT is connected to the first terminal of the capacitor.

4. The array substrate according to claim 3, wherein the charging power supply is a second gate line which is one of the gate lines before the first gate line and adjacent to the first gate line; and the first power supply is a common electrode line formed on the array substrate.

5. The array substrate according to claim 1, wherein the source and the drain electrodes of the sensing TFT are both of a comb structure.

6. The array substrate according to claim 1, wherein the signal line of the touch-sensitive pixel is arranged in parallel to the data lines.

7. A color-filter substrate comprising color filters for different colors, a black matrix and spacers including primary spaces and secondary spacers, wherein,
the black matrix includes sensing areas each arranged in opposite to one of the touch-sensitive pixel areas of the array substrate according to claim 1 and for covering the touch-sensitive pixel areas;
the secondary spacers are arranged on the sensing areas of the black matrix and each in opposite to the sensing TFT and the capacitor of one touch-sensitive pixel; a first terminal of each secondary spacer abuts against the black matrix, and a second terminal thereof is opposite to the sensing TFT and the capacitor of the touch-sensitive pixel.

8. The color-filter substrate according to claim 7, wherein a surface of the second terminal of each secondary spacer is provided with a reflection layer for reflecting light to the sensing TFT of the corresponding touch-sensitive pixel on the array substrate.

9. The color-filter substrate according to claim 8, wherein the reflection layer comprises copper or aluminum.

10. A liquid crystal display including:
a backlight,
an array substrate according to claim 1,
a color-filter substrate according to claim 7,
a driving circuit, and
spacers arranged between the array substrate and the color-filter substrate that are assembled with facing each other, wherein
the spacers include primary spacers and secondary spacers, two terminals of each primary spacer are respectively in contact with the array substrate and the color-filter substrate, and a first terminal of each secondary spacer is arranged on the black matrix and a second terminal of the secondary spacer is opposite to the array substrate but not in contact with the array substrate,
each sensing area of the black matrix on the color-filter substrate is arranged in opposite to one touch-sensitive pixel area on the array substrate, and covers the touch-sensitive pixel area; the second terminal of each secondary spacer is arranged in opposite to the sensing TFT and the capacitor of one touch-sensitive pixel; and
the driving circuit is used to drive the liquid crystal display, and is connected to the signal lines arranged on the array substrate and used to process electrical signals received from the signal lines to perform a touch addressing.

11. The liquid crystal display according to claim 10, wherein the driving circuit includes:
an amplifying unit connected to the signal lines arranged on the array substrate, for amplifying the electrical signal received from the signal lines.
